(19) United States
(12) Patent Application Publication
(10) Pub. No.: US 2011/0247742 A1
(43) Pub. Date: Oct. 13, 2011

(54) Method of making building boards having predetermined size and precise dimensions

(76) Inventor: Henry Halpert, Brooklyn, NY (US)

(21) Appl. No.: 12/798,740

(22) Filed: Apr. 12, 2010

(51) Int. Cl. B32B 37/14

(52) U.S. Cl. 156/44

(57) ABSTRACT

A method is provided for cutting a slab of gypsum board in two sections using a single cord in either the longitudinal direction or lateral direction. The cord is fixed at one edge and is placed between the gypsum and a liner sheet coextensively adhered to the board surface. By pulling the cord away, the board is cut into two sections of predetermined sizes and precise dimensions.

### FIELD OF THE INVENTION

The present invention relates generally to building boards for use in the building and construction industries and is particularly related to a method of making such building boards, including gypsum boards, having predetermined and precise sizes and dimensions for residential and commercial construction.

### BACKGROUND OF THE INVENTION

Gypsum wallboard, also known as sheetrock and plasterboard, is a widely used material of construction, both for residential as well as commercial buildings. Indeed the manufacture of gypsum wallboards and their use in building construction have been described in several prior art patents. For example, as disclosed in U.S. Pat. No. 4,858,402 issued Aug. 22, 1989, according to the prior art gypsum boards are made in large quantities and are sold in standardized sizes. Before installation, they must be cut to precise sizes and dimensions and marked to indicate fixing points for the receiving nails, studs and other fasteners. For more efficient installation of these boards, the aforementioned patent describes a method of applying to the board markings in the form of paints which fade by exposure to light. These marks facilitate cutting of the board, placing and fastening them to construct a wall. The markings will eventually fade so that the wall can be painted without visible indication of the markings.

U.S. Pat. No. 6,760,978 issued Jul. 13, 2004 discloses building sheets having a plurality of surface grooves to facilitate cutting the sheet along the grooves.

U.S. Pat. No. 6,880,299 issued Apr. 19, 2005, there is described a drywall having sets of indicia which indicate the relative positions of wall supports.

A more recent patent, i.e. U.S. Pat. No. 7,254,894 issued Aug. 14, 2007, describes a method of making building boards such as gypsum board having a desired size and precise dimensions which make them simple and economical to install in construction of commercial and residential buildings. A large slab or web of a gypsum board is marked on both of its major surfaces with markings which are formed transversely on one surface and longitudinally on the opposed parallel surface. The marks are formed in the positions at which the board is to be cut or broken to that size. A cord or a string is embedded along each marking and may project beyond the edges of the board. A sheet liner such as releasable paper is coextensively adhered to each surface and is adapted to be peeled away from its respective surface by pulling up and away of the string along its associated marking.

The methods described in the aforementioned prior art patents have not been entirely satisfactory. They are generally time consuming, result in unevenly cut boards and are generally costly to install.

Therefore, it is an object of the present invention to provide a simple and effective method of making building boards having predetermined sizes and precise dimensions suitable for the building and construction industry.

It is also an object of this invention to cut prefabricated gypsum boards to the desired predetermined sizes and precise dimensions for ready installation when constructing a wall or a ceiling in commercial and residential buildings.

The foregoing and other objects and features of the present invention will be more fully appreciated from the following detailed description and the corresponding drawings.

### SUMMARY OF THE INVENTION

The present invention provides a method of making gypsum boards having predetermined sizes and precise dimensions. According to the method of this invention, a slab of a gypsum board is cut into two sections using a single cord in the longitudinal direction or in the lateral direction. No markings are required to mark the positions of the cords such as when the board is intended to be cut in several sections. Thus, a single cord may be fixed in the middle of one edge (lateral edge or longitudinal edge) and the cord is extended and fixed in position by a suitable adhesive. The cord may be pre-coated with the adhesive and fixed along the board, between the gypsum surface and a sheet liner which is coextensively adhered to each surface of the board.

In another aspect of the method of this invention, one cord may be fixed along the longitudinal direction on one surface and another cord may be fixed along the lateral direction on the opposite surface without interfering with each other when one of the cords is pulled to cut the board in two sections.

### BRIEF DESCRIPTION OF THE DRAWINGS

In the drawings wherein like reference numerals are employed to designate like parts:

FIG. 1 is perspective view of a gypsum board used in the present invention showing a cord attached at one edge and adapted to be extended in the longitudinal direction of the board;

FIG. 2 is perspective view of the reverse side of the board shown in FIG. 1;

FIG. 3 is a perspective view of a gypsum board as in FIG. 1 showing a cord attached at the longitudinal edge of the board adapted to be extended in the width (lateral) direction of the board;

FIG. 4 is a perspective of the reverse side of the board shown in FIG. 3;

FIG. 5 is a perspective view of a different gypsum board for use in the present invention but wherein the board is tapered at its upper surface, and

FIG. 6 is a schematic representation of a method illustrating how the cord is applied to sheet liner (paper) of the board in the longitudinal direction.

### DETAILED DESCRIPTION OF THE INVENTION

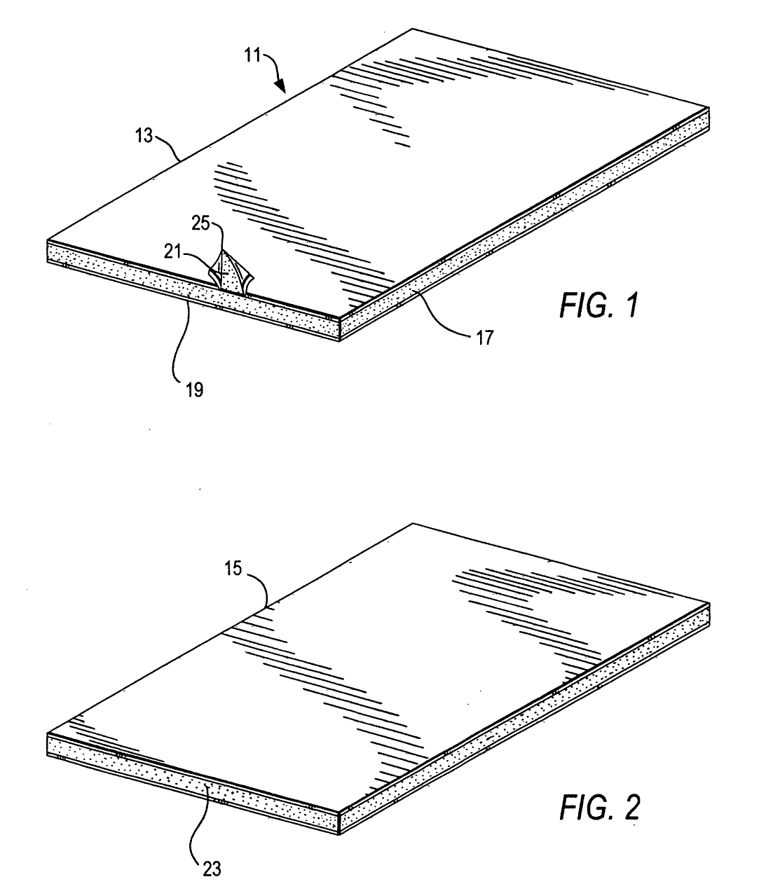

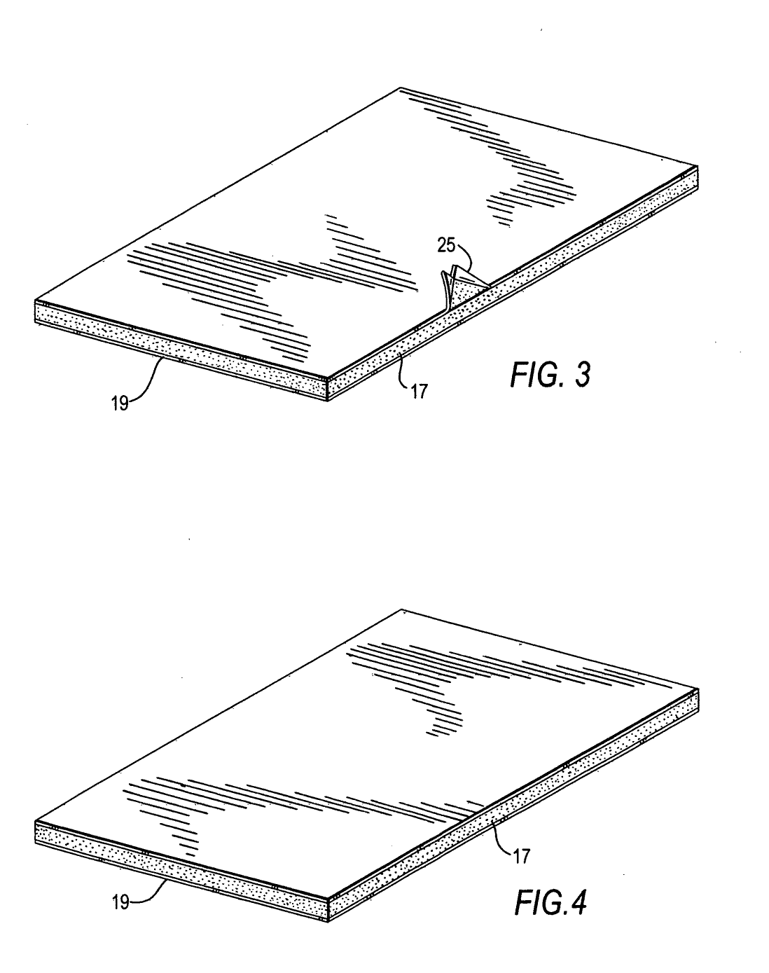

Referring to the drawings there is shown in FIG. 1 and FIG. 2 a gypsum board 11 cut from a slab in rectangular form. The gypsum board 11 is defined by opposed spaced apart parallel top and bottom (reverse) surfaces 13,15 separated by the edges 17,19 which are of specified desired thickness. The top surface 13 and the bottom surface 15 is each covered coextensively with a sheet liner such as releasable paper 21 adhered to the top surface 13, and a releasable paper 23 adhered to the bottom surface 15. As shown in FIG. 1 a cord or a string 25 is fixed at one end at the middle of edge 19 and extends to the opposite edge. Alternatively, as shown in FIG. 3, a cord or string 25 is fixed at one end in the middle of the edge 17 and extends to the opposite edge. Thus, one cord can be extended longitudinally and another cord extended in the lateral (width) direction depending on the size and shape of the desired board sections.

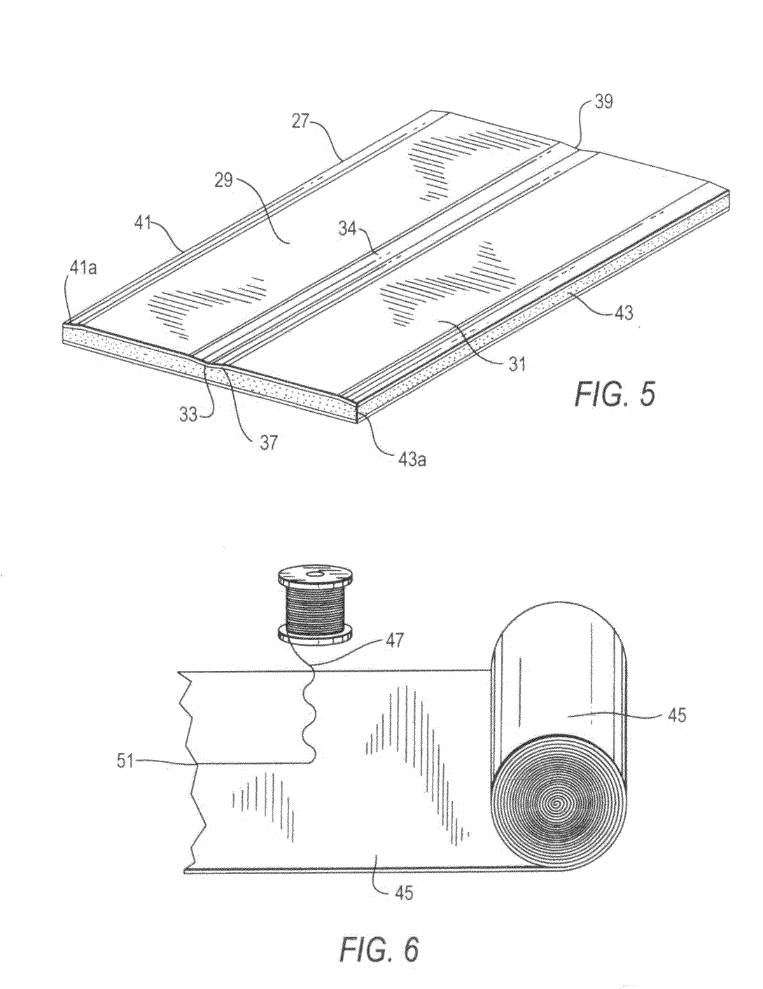

FIG. 5 shows a different gypsum board 27 having opposed spaced apart parallel surfaces 29,31 and a sheet liner such as a releasable paper 33 coextensively attached to the upper surface 29. The upper surface 29 of the board has a tapered mid-portion 34 extending from the edge 37 to the opposite edge 39 and is also tapered at the end of the longitudinal edges 41,43 as at 41a and 43a.

Referring back to FIGS. 1-4, in order to cut a board section, the cords, which may partly extend beyond the edge 19 is grasped between the fingers and pulled away in the longitudinal direction (FIG. 1) or in the lateral direction (FIG. 3) thereby tearing the sheet liner and thus cutting the board to the desired predetermined size and dimensions.

The method of applying a cord or a string is illustrated schematically in FIG. 6. Thus, as shown in FIG. 6 a roll of paper 45 (the sheet liner) is partly unwound from the right to left direction; and a roll of cord 47 is shown which can be activated mechanically or by hand to dispense the cord 51 and applied to the paper liner 45 as the paper roll is unwound.

In order to adequately secure the cord to the sheet liner, the cord may be pretreated with a suitable adhesive to insure that the cord is not displaced in either direction since that could result in uneven cutting of the board. Alternatively, the adhesive may be applied to the cord as the cord is placed in position thus fixing the cord on the sheet liner surface.

The adhesive may be applied to the cord by dipping the cord in a vessel containing the adhesive until the cord is completely covered with the adhesive. Alternatively, the cord may be extruded through the adhesive vessel in order to completely coat the cord. Regardless of which method is used, it can be appreciated that the purpose is to coat the cord to facilitate its application to the paper liner between the gypsum and the board surface.

Several adhesives are suitable for coating the cord. These adhesives include starch based adhesives, acrylic based adhesives, cyanoacrylate based adhesives, epoxy resins and ethylene, vinyl acetate based adhesives. In selecting the adhesive of choice, the most important physical properties of the adhesive are high degree of tackiness at room temperature, excellent adhesion to the paper liner, satisfactory initial shear resistance to prevent cord movement when in the slurry, and proper glass transition temperature (Tg). In general the lower the Tg, the greater the initial adhesion tack. Suitable adhesive are either hot melt (100% solid) or water emulsions (50-75% solids).

The most preferred adhesives are the acrylic type adhesives available from Rohm and Hass, Philadelphia, Pa., several of those adhesives which are conveniently available are: Robond Prohesion 3100: Acrylic; water emulsion (milky white liquid); 51% solids; Tg=−32 degrees C.; Robond Prohesion 3200: Acrylic; water emulsion (milky white liquid); 51% solids; Tg=−23 degrees C.; Robond PS 2020: Acrylic; water emulsion (milky white liquid); 53.5% solids; Tg=−41 degrees C.; Robond PS 35: Acrylic; water emulsion (milky white liquid); 54% solids; Tg=−40 degrees C.; Robond PS 7440: Acrylic; water emulsion (milky white liquid) 54% solids: Tg=−32 degrees C.; Mor-Melt R-5022: solid (100% solids); melt at 120 degrees C.; viscosity 14000 to 20000 cps; 3M Fastbond 4224NF: Acrylic; water emulsion (milky white liquid) 54% solids; Tg not revealed but estimated in the range of −30 to −40 degrees Centigrade.

As it can be appreciated from the foregoing description, the method of this invention does not require plurality of markings on the surfaces of the gypsum board since that may result in undesirable markings on the surface of the board. By using a gypsum board of a given length, the board may be cut in two sections using a single cord under the liner either in the longitudinal direction or in the lateral direction to make boards of predetermined sizes and precise dimensions. As it can be further appreciated, the cord can be secured in position by coating the cord with a proper adhesive to insure that the cord is securely embedded along its length. Other variations and modifications are obvious from the foregoing description and are within the scope of the present disclosure.

1. A method of making building boards with predetermined sizes and precise dimensions for use in the construction of commercial and residential buildings, which method comprises using a gypsum board having spaced apart opposed parallel surfaces and a sheet liner coextensively adhered to the gypsum on each of said opposed surfaces, placing one cord between said liner and the gypsum, and pulling said cord thereby cutting said liner and breaking said board into two sections having predetermined sizes and precise dimensions.

2. A method as in claim 1 wherein a single cord is placed parallel to the longitudinal direction of said board.

3. A method as in claim 2 wherein a single cord is placed midway along the longitudinal direction of said board.

4. A method as in claim 3 wherein a single cord is placed a finite distance from the edge of said board.

5. A method as in claim 1 wherein a single cord is placed perpendicular to the longitudinal direction of said board.

6. A method as in claim 2 wherein a single cord is placed perpendicular to the longitudinal direction of said board.

7. A method of making building boards having predetermined sizes and precise dimensions for use in the construction of commercial and residential buildings, which method comprises using a gypsum board having spaced apart opposed parallel surfaces and a sheet liner coextensively adhered to the gypsum on each of said opposed surfaces, placing a first cord between said liner and the gypsum along the longitudinal direction of said board, and placing a second cord between said liner and the gypsum perpendicular to the longitudinal direction on opposite surface of said board.

8. A method of making building boards as in claim 7 wherein said first cord is placed midway along the longitudinal direction of said board.

9. A method of making building boards as in claim 1 wherein said cord is adhesively attached between said liner and the gypsum surface.

10. A method of making building boards as in claim 2 wherein said cord is adhesively attached between said liner and the gypsum surface.

11. A method of making building boards as in claim 3 wherein said cord is adhesively attached between said liner and the gypsum surface.

12. A method of making building boards as in claim 4 wherein said cord is adhesively attached between said liner and the gypsum surface.

13. A method of making building boards as in claim 5 wherein said cord is adhesively attached between said liner and the gypsum surface.

14. A method of making building boards as in claim 6 wherein said cord is adhesively attached between said liner and the gypsum surface.

15. A method of making building boards as in claim 8 wherein said cord is adhesively attached between said liner and the gypsum surface.

16. A method of making building boards as in claim 1 wherein said cord is pretreated with an adhesive.

17. A method of making building boards as in claim 2 wherein said cord is pretreated with an adhesive.

18. A method of making building boards as in claim 3 wherein said cord is pretreated with an adhesive.

19. A method of making building boards as in claim 4 wherein said cord is pretreated with an adhesive.

20. A method of making building boards as in claim 5 wherein said cord is pretreated with an adhesive.

21. A method of making building boards as in claim 6 wherein said cord is pretreated with an adhesive.

22. A method of making building boards as in claim 7 wherein said cord is pretreated with an adhesive.

23. A method of making building boards as in claim 8 wherein said cord is pretreated with an adhesive.

24. A method of making building boards with predetermined sizes and precise dimensions for use in the construction of commercial and residential buildings, which method comprises using a gypsum board having spaced apart opposed parallel surfaces and a sheet liner coextensively adhered to the gypsum on each of said opposed surfaces, placing one cord between said liner and said gypsum, forming a taper on said board above the placement of the cord, and pulling said cord thereby cutting said liner and breaking said board into two sections having predetermined sizes and precise dimensions and tapered edges.

25. A method of making a building board as in claim 24 wherein said board is pretreated with adhesive.

26. A method of making building boards having predetermined sizes and precise dimensions for use in the construction of commercial and residential buildings, which method comprises using a gypsum board having spaced apart opposed parallel surfaces and a sheet liner coextensively adhered to the gypsum on each of said opposed surfaces, placing a first cord between said liner and said gypsum along the longitudinal direction of said board, forming a taper on said board above the placement of the cord, and placing a second cord between said liner and the gypsum perpendicular to the longitudinal direction on opposite surface of said board.

27. A method of making building boards as in claim 26 wherein said board is pretreated with adhesive.

28. A gypsum board having predetermined size and precise dimensions for use in the construction of commercial and residential buildings, said board being defined by spaced apart opposed parallel top and bottom surfaces separated by a longitudinal edge and a transverse edge, a sheet liner coextensively attached to said top surface and to said bottom surface, a cord between said liner and said gypsum, said cord having one end fixed midway from said transverse edge and adapted to be pulled in the longitudinal direction thereby cutting said board into two sections having predetermined sizes and precise dimensions.

29. A gypsum board as in claim 28 wherein said cord is adhesively attached between said liner and said gypsum surface.

30. A gypsum board as in claim 28 wherein a single cord is placed a finite distance from the edge of said board.

31. A gypsum board having predetermined size and precise dimensions for use in the construction of commercial and residential buildings, said board being defined by spaced apart opposed parallel top and bottom surfaces separated by a longitudinal edge and a transverse edge, a sheet liner coextensively attached to said top surface and to said bottom surface, a first cord between said liner and the gypsum along the longitudinal direction of each board, and said first cord having an end fixed midway from said transverse edge, and a second cord between said liner and said gypsum, perpendicular to the longitudinal direction of opposed surface of said board, said second cord having an end fixed midway of said perpendicular edge.

32. A gypsum board as in claim 31 wherein a single cord is place a finite distance from the edge of said board.

33. A gypsum board as in claim 31 wherein said cord is adhesively attached between said liner and said gypsum surface.

34. A gypsum board having predetermined size and precise dimensions for use in the construction of commercial and residential buildings, said board being defined by spaced apart opposed parallel top and bottom surfaces separated by a longitudinal edge and a transverse edge, a sheet liner coextensively attached to said top surface and to said bottom surface, a cord placed between said liner and said gypsum, said cord having an end fixed midway from said transverse edge, and a tapered portion formed on said board above said cord, said cord and said tapered portion extending from transverse edge to opposite transverse edge of said liner.

35. A gypsum board as in claim 34 wherein a single cord is placed a finite distance from the edge of said board.

36. A gypsum board as in claim 34 wherein said cord is adhesively attached to said liner and said gypsum surface.
